(19) United States
(12) Patent Application Publication
(10) Pub. No.: US 2024/0241733 A1
(43) Pub. Date: Jul. 18, 2024

(54) Industrial Ethernet Configuration Tool With Preview Capabilities

(71) Applicant: ZEBRA TECHNOLOGIES CORPORATION, Lincolnshire, IL (US)

(72) Inventors: David D. Landron, Coram, NY (US); Christopher M. West, South Setauket, NY (US); Matthew M. Degen, Ridge, NY (US)

(21) Appl. No.: 18/288,942

(22) PCT Filed: Apr. 22, 2022
(86) PCT No.: PCT/US22/26009

§ 371 Date: Oct. 30, 2023

Related U.S. Application Data
(63) Continuation of application No. 17/389,078, filed on Jul. 29, 2021, now abandoned.
(60) Provisional application No. 63/182,491, filed on Apr. 30, 2021.

(51) Int. Cl. G06F 9/445; G06F 3/0482; G06F 9/48; G06T 1/00; H04L 67/125

(52) U.S. Cl. CPC G06F 9/44505; G06F 3/0482; G06F 9/4843; G06T 1/0014; H04L 67/125; G06T 2200/24

(57) ABSTRACT

An industrial Ethernet configuration tool with preview capabilities is disclosed herein. An example implementation includes a computing device for executing an application, the application operable to configure a machine vision job, wherein configuring the machine vision job includes: (1) configuring at least one tool to be executed by the imaging device during an execution of the job; (2) configuring an output data stream based on the at least one tool, the output data stream being formatted for communication to the a third-party computing device; and (3) displaying a representation of an output message, the output message being formed based on: (i) the configuring the output data stream, and (ii) previously acquired job run data, the output message being a representation of a transmission of a message from the imaging device to the third-party computing device.

### CROSS-REFERENCE TO RELATED APPLICATIONS

The current application is a national stage of a Patent Cooperation Treaty Application PCT/US2022/26009 filed on Apr. 22, 2022, which is a Patent Cooperation Treaty Application of U.S. patent application Ser. No. 17/389,078, filed on Jul. 29, 2021, which claims priority to U.S. Provisional Application No. 63/182,491, filed on Apr. 30, 2021, all of which are incorporated herein by reference in their entirety.

### BACKGROUND

Over the years, Industrial Automation has come to rely heavily on Machine Vision components capable of assisting operators in a wide variety of tasks. In some implementations, Machine Vision components, like cameras, are utilized to track objects, like those which move on a conveyor belt past stationary cameras. Often, these cameras (also referred to as Imaging devices) interface with third-party computing devices like programmable logic controllers (PLC). This interaction, however, can be problematic due to the fact that PLCs often have limited capabilities and must be programmed in accordance with a specific communication protocol used by that specific PLC. Consequently, imaging device outputs are typically transmitted to a PLC as a binary representation of the output data. Due to their simplicity, such outputs can be difficult to decipher for purposes of programming the PLC to properly accept the message. Thus, there is a need for improved systems, devices, and methods which facilitate easier programming of PLCs to properly receive machine vision data from machine vision devices.

### SUMMARY

In an embodiment, the present invention is a method for operating a machine vision system, the machine vision system including a computing device for executing an application and an imaging device communicatively coupled to the computing device, the imaging device being operable to communicate with a third-party computing device. The method may include: configuring, via the application, a machine vision job, the configuring the machine vision job including: configuring at least one tool to be executed by the imaging device during an execution of the job; configuring an output data stream based on the at least one tool, the output data stream being formatted for communication to the third-party computing device; and displaying, via the application, a representation of an output message, the representation of the output message being formed based on the configuring the output data stream, the representation of the output message being a representation of a transmission of a payload message from the imaging device to the third-party computing device. The method may further include: transmitting, from the computing device to the imaging device, the machine vision job; and executing the machine vision job on the imaging device, wherein, the executing the machine vision job includes transmitting the payload message from the imaging device to the third-party computing device.

In a variation of this embodiment, the representation of the output message is a binary representation of the output data stream.

In another variation of this embodiment, the displaying the representation of the output message occurs in response to the configuring the output data stream.

In another variation of this embodiment, the third-party computing device is a programmable logic controller (PLC).

In another variation, configuring an output data stream based on the at least one tool further comprises: displaying, based on the at least one tool, a plurality of fields for selection by a user; receiving, from the user, a selection of at least one field of the plurality of fields; and configuring the at least one tool further based on the selected at least one field.

In another variation, configuring an output data stream based on the at least one tool further comprises: displaying a size field for each field of the plurality of fields; receiving, from a user, an input for at least one of the size fields; and configuring the output data stream further based on the received input.

In another variation, displaying, via the application, a representation of an output message further comprises: displaying the representation of the output message in an entry mode by adding a header comprising metadata to the output message.

In another variation, displaying, via the application, a representation of an output message further comprises: displaying the representation of the output message in a raw data mode by displaying raw data of the output message, and not adding a header comprising metadata to the output message.

In another variation, the configuring the output data stream based on the at least one tool includes executing each of the at least one tool with a respective input data set to receive a corresponding output data set.

In another variation, the representation of the output message is formed further based on a prior image.

In another embodiment, the invention is a machine vision system comprising a computing device for executing an application, the application operable to configure a machine vision job, wherein configuring the machine vision job includes: configuring at least one tool to be executed by the imaging device during an execution of the job; configuring an output data stream based on the at least one tool, the output data stream being formatted for communication to a third-party computing device; and displaying, via the application, a representation of an output message, the representation of the output message being formed based on the configuring the output data stream, the output message being a representation of a transmission of a payload message from the imaging device to the third-party computing device, wherein the displayed representation of the output message is formed further based on at least one of: (i) user-entered data, (ii) prior image data, or (iii) default data. The application may be further operable to cause the computing device to transmit the machine vision job to an imaging device; and the imaging device may be further configured to receive the machine vision job and to execute the machine vision job which includes transmitting the payload message from the imaging device to the third-party computing device.

In a variation of this embodiment, configuring the machine vision job further includes forming the displayed representation of the output message further based on the user-entered data.

In another variation of this embodiment, configuring the machine vision job further includes forming the displayed representation of the output message further based on the prior image data.

In another variation, the representation of the output message is a binary representation of the output data stream.

In another variation, the displaying the representation of the output message occurs in response to the configuring the output data stream.

In another variation, the third-party computing device is a programmable logic controller (PLC).

In another variation, displaying, via the application, a representation of an output message further comprises: displaying the representation of the output message in an entry mode by adding a header comprising metadata to the output message.

In another embodiment, the invention is a machine vision system comprising a computing device for executing an application. The application is operable to configure a machine vision job, and the application is further operable to display a representation of an input message by: configuring, via the application, a machine vision job, the configuring the machine vision job including configuring at least one tool to be executed by an imaging device during an execution of the job; receiving, from a third-party computing device, a desired output of the machine vision job; determining, via the application, the representation of the input message based on: (i) the configured machine vision job, and (ii) the desired output of the machine vision job; and displaying, via the application, the determined representation of the input message.

A variation of this embodiment further includes the imaging device, wherein the imaging device is configured to receive the machine vision job and to execute the machine vision job which includes transmitting the message from the imaging device to the third-party computing device.

In a variation of this embodiment, the third-party computing device comprises a programmable logic controller (PLC).

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example system for optimizing one or more imaging settings for a machine vision job, in accordance with embodiments described herein.

FIG. 2 is a perspective view of the imaging device of FIG. 1, in accordance with embodiments described herein.

FIG. 3 depicts an example application interface utilized to optimize one or more jobs, in accordance with embodiments described herein.

FIG. 4 depicts an additional example application interface including an application of the binarize tool.

FIG. 5 depicts an example interface for specifying input and output parameters for the imaging device that is to execute the previously built job.

FIG. 6 depicts an example interface resulting from a selection of “ADD” from FIG. 5.

FIG. 7 depicts an example screen resulting from a selection of the “pixel_count” output.

FIG. 8 depicts an example screen resulting from a selection of the “pixel_count_max” output.

FIG. 9 depicts an example screen resulting from a selection of a “Locate Object 1” tool.

FIG. 10 depicts an example screen resulting from a selection of “SUBMIT.”

FIG. 11 depicts an example screen where the “Read Barcode 1” tool has been selected.

FIG. 12 depicts an example screen where the “Pixel Count 1” tool has been selected.

FIG. 13 illustrates an example screen to display a representation of an input message to be input to the imaging device.

FIG. 14A depicts an example of determining a preview message of output data.

FIG. 14B depicts an example of determining a preview message of input data.

FIG. 15 illustrates an example method of displaying a representation of a transmission of a message output from the imaging device to the third party computing device.

FIG. 16 illustrates an example method of displaying a representation of a transmission of a message input to the imaging device from the third party computing device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

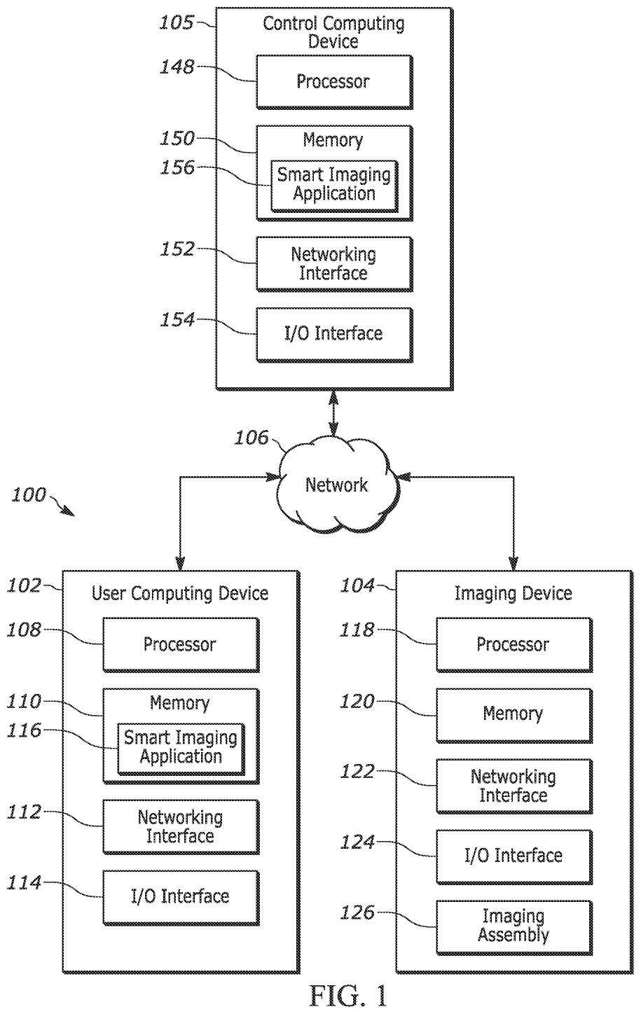

FIG. 1 illustrates an example imaging system 100 configured to analyze pixel data of an image of a target object to execute a machine vision job, in accordance with various embodiments disclosed herein. In the example embodiment of FIG. 1, the imaging system 100 includes a user computing device 102 (e.g., a computer, mobile device, or a tablet), a control computing device 105 (e.g., a programmable logic controller (PLC)), and an imaging device 104 communicatively coupled to the user computing device 102 and the control computing device 105 via a network 106. Generally speaking, the user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to create a machine vision job for execution on the imaging device 104. When created, the user/operator may then transmit/upload the machine vision job to the imaging device 104 via the network 106, where the machine vision job is then interpreted and executed. Upon the execution of these jobs, output data generated by the imaging device 104 can be transmitted to the control computing device 105 for further analysis and use. The user computing device 102 may comprise one or more operator workstations, and may include one or more processors 108, one or more memories 110, a networking interface 112, an input/output (I/O) interface 114, and a smart imaging application 116. Similarly, the control computing device 105 may include one or more processors 148, one or more memories 150, a networking interface 152, an input/output (I/O) interface 154, and software (potentially executing in the form of firmware) such as smart imaging application 156.

The imaging device 104 is connected to the user computing device 102 via a network 106, and is configured to interpret and execute machine vision jobs received from the user computing device 102. Generally, the imaging device 104 may obtain a job file containing one or more job scripts from the user computing device 102 across the network 106 that may define the machine vision job and may configure the imaging device 104 to capture and/or analyze images in accordance with the machine vision job. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more job scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically perform sufficient functionality of the imaging device 104 in order to obtain, interpret, and execute job scripts that define machine vision jobs, such as any one or more job scripts contained in one or more job files as obtained, for example, from the user computing device 102.

Broadly, the job file may be a JSON representation/data format of the one or more job scripts transferrable from the user computing device 102 to the imaging device 104. The job file may further be loadable/readable by a C++ runtime engine, or other suitable runtime engine, executing on the imaging device 104. Moreover, the imaging device 104 may run a server (not shown) configured to listen for and receive job files across the network 106 from the user computing device 102. Additionally or alternatively, the server configured to listen for and receive job files may be implemented as one or more cloud-based servers, such as a cloud-based computing platform. For example, the server may be any one or more cloud-based platform(s) such as MICROSOFT AZURE, AMAZON AWS, or the like.

In any event, the imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data that may be analyzed by one or more tools each configured to perform an image analysis task. The digital camera and/or digital video camera of, e.g., the imaging assembly 126 may be configured, as disclosed herein, to take, capture, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. In various embodiments, the imaging assembly may additionally include a three-dimensional (3D) camera (not shown) for capturing, sensing, or scanning 3D image data. The 3D camera may include an Infra-Red (IR) projector and a related IR camera for capturing, sensing, or scanning 3D image data/datasets. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. Consequently, the captured 2D images and the corresponding 2D image data may be depth-aligned with the 3D images and 3D image data.

In embodiments, imaging assembly 126 may be configured to capture images of surfaces or areas of a predefined search space or target objects within the predefined search space. For example, each tool included in a job script may additionally include a region of interest (ROI) corresponding to a specific region or a target object imaged by the imaging assembly 126. The composite area defined by the ROIs for all tools included in a particular job script may thereby define the predefined search space which the imaging assembly 126 may capture in order to facilitate the execution of the job script. However, the predefined search space may be user-specified to include a field of view (FOV) featuring more or less than the composite area defined by the ROIs of all tools included in the particular job script. It should be noted that the imaging assembly 126 may capture 2D and/or 3D image data/datasets of a variety of areas, such that additional areas in addition to the predefined search spaces are contemplated herein. Moreover, in various embodiments, the imaging assembly 126 may be configured to capture other sets of image data in addition to the 2D/3D image data, such as grayscale image data or amplitude image data, each of which may be depth-aligned with the 2D/3D image data.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the smart imaging application 116 for viewing, manipulation, and/or otherwise interaction. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120, 150 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., smart imaging application 116, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118, 148 (e.g., working in connection with the respective operating system in the one or more memories 110, 120, 150) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120, 150 may store an operating system (OS) (e.g., Microsoft Windows, Linux, Unix, etc.) capable of facilitating the functionalities, apps, methods, or other software as discussed herein. The one or more memories 110 may also store the smart imaging application(s) 116 and/or 156, which may be configured to enable machine vision job construction, as described further herein. Additionally, or alternatively, the smart imaging application 116 may also be stored in the one or more memories 120 of the imaging device 104, and/or in an external database (not shown), which is accessible or otherwise communicatively coupled to the user computing device 102 via the network 106. Additionally or alternatively, the one or more memories 150 may store the smart imaging application(s) 116 and/or 156, which may be configured to enable machine vision job construction, as described further herein. Additionally, or alternatively, the smart imaging application 156 may also be stored in the one or more memories 120 of the imaging device 104, and/or in an external database (not shown), which is accessible or otherwise communicatively coupled to the user computing device 102 via the network 106. In some implementations, the smart imaging applications 116 and 156 are the same application. In other implementations, the smart imaging applications 116 and 156 are different applications. The one or more memories 110, 120, 150 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the smart imaging application 116, 156, where each may be configured to facilitate their various functionalities discussed herein. It should be appreciated that one or more other applications may be envisioned and that are executed by the one or more processors 108, 118, 148.

The one or more processors 108, 118, 148 may be connected to the one or more memories 110, 120, 150 via a computer bus responsible for transmitting electronic data, data packets, or otherwise electronic signals to and from the one or more processors 108, 118, 148 and one or more memories 110, 120, 150 in order to implement or perform the machine readable instructions, methods, processes, elements or limitations, as illustrated, depicted, or described for the various flowcharts, illustrations, diagrams, figures, and/or other disclosure herein.

The one or more processors 108, 118, 148 may interface with the one or more memories 110, 120, 150 via the computer bus to execute the operating system (OS). The one or more processors 108, 118, 148 may also interface with the one or more memories 110, 120, 150 via the computer bus to create, read, update, delete, or otherwise access or interact with the data stored in the one or more memories 110, 120, 150 and/or external databases (e.g., a relational database, such as Oracle, DB2, MySQL, or a NoSQL based database, such as MongoDB). The data stored in the one or more memories 110, 120, 150 and/or an external database may include all or part of any of the data or information described herein, including, for example, machine vision job images (e.g., images captured by the imaging device 104 in response to execution of a job script) and/or other suitable information.

The networking interfaces 112, 122, 152 may be configured to communicate (e.g., send and receive) data via one or more external/network port(s) to one or more networks or local terminals, such as network 106, described herein. In some embodiments, networking interfaces 112, 122, 152 may include a client-server platform technology such as ASP.NET, Java J2EE, Ruby on Rails, Node.js, a web service or online API, responsive for receiving and responding to electronic requests. The networking interfaces 112, 122, 152 may implement the client-server platform technology that may interact, via the computer bus, with the one or more memories 110, 120, 150 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122, 152 may include, or interact with, one or more transceivers (e.g., WWAN, WLAN, and/or WPAN transceivers) functioning in accordance with IEEE standards, 3GPP standards, 4G, 5G, 6G or other standards, and that may be used in receipt and transmission of data via external/network ports connected to network 106. In some embodiments, network 106 may comprise a private network or local area network (LAN). Additionally or alternatively, network 106 may comprise a public network such as the Internet. In some embodiments, the network 106 may comprise routers, wireless switches, or other such wireless connection points communicating to the user computing device 102 (via the networking interface 112), the control computing device 105 (via networking interface 152), and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124, 154 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, and/or other suitable visualizations or information. For example, the user computing device 102, control computing device 105, and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124, 154 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102, control computing device 105, and/or the imaging device 104. According to some embodiments, an administrator or user/operator may access the user computing device 102, control computing device 105, and/or imaging device 104 to construct jobs, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

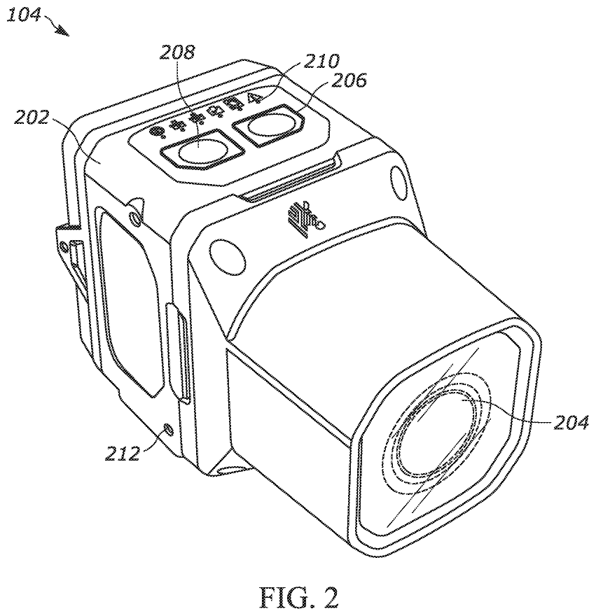

FIG. 2 is a perspective view of the imaging device 104 of FIG. 1, in accordance with embodiments described herein. The imaging device 104 includes a housing 202, an imaging aperture 204, a user interface label 206, a dome switch/button 208, one or more light emitting diodes (LEDs) 210, and mounting point(s) 212. As previously mentioned, the imaging device 104 may obtain job files from a user computing device (e.g., user computing device 102) which the imaging device 104 thereafter interprets and executes. The instructions included in the job file may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 204. As an example, assume that at least a portion of the intended analysis corresponding to a machine vision job requires the imaging device 104 to maximize the brightness of any captured image. To accommodate this requirement, the job file may include device configuration settings to increase the aperture size of the imaging aperture 204. The imaging device 104 may interpret these instructions (e.g., via one or more processors 118) and accordingly increase the aperture size of the imaging aperture 204. Thus, the imaging device 104 may be configured to automatically adjust its own configuration to optimally conform to a particular machine vision job. Additionally, the imaging device 104 may include or otherwise be adaptable to include, for example but without limitation, one or more bandpass filters, one or more polarizers, one or more DPM diffusers, one or more C-mount lenses, and/or one or more C-mount liquid lenses over or otherwise influencing the received illumination through the imaging aperture 204.

The user interface label 206 may include the dome switch/button 208 and one or more LEDs 210, and may thereby enable a variety of interactive and/or indicative features. Generally, the user interface label 206 may enable a user to trigger and/or tune to the imaging device 104 (e.g., via the dome switch/button 208) and to recognize when one or more functions, errors, and/or other actions have been performed or taken place with respect to the imaging device 104 (e.g., via the one or more LEDs 210). For example, the trigger function of a dome switch/button (e.g., dome/switch button 208) may enable a user to capture an image using the imaging device 104 and/or to display a trigger configuration screen of a user application (e.g., smart imaging application 116). The trigger configuration screen may allow the user to configure one or more triggers for the imaging device 104 that may be stored in memory (e.g., one or more memories 110, 120) for use in later developed machine vision jobs, as discussed herein.

As another example, the tuning function of a dome switch/button (e.g., dome/switch button 208) may enable a user to automatically and/or manually adjust the configuration of the imaging device 104 in accordance with a preferred/predetermined configuration and/or to display an imaging configuration screen of a user application (e.g., smart imaging application 116). The imaging configuration screen may allow the user to configure one or more configurations of the imaging device 104 (e.g., aperture size, exposure length, etc.) that may be stored in memory (e.g., one or more memories 110, 120) for use in later developed machine vision jobs, as discussed herein.

To further this example, and as discussed further herein, a user may utilize the imaging configuration screen (or more generally, the smart imaging application 116, 156) to establish two or more configurations of imaging settings for the imaging device 104. The user may then save these two or more configurations of imaging settings as part of a machine vision job that is then transmitted to the imaging device 104 in a job file containing one or more job scripts. The one or more job scripts may then instruct the imaging device 104 processors (e.g., one or more processors 118) to automatically and sequentially adjust the imaging settings of the imaging device in accordance with one or more of the two or more configurations of imaging settings after each successive image capture.

The mounting point(s) 212 may enable a user connecting and/or removably affixing the imaging device 104 to a mounting device (e.g., imaging tripod, camera mount, etc.), a structural surface (e.g., a warehouse wall, a warehouse ceiling, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 212 may enable a user to connect the imaging device 104 to a myriad of accessory items including, but without limitation, one or more external illumination devices, one or more mounting devices/brackets, and the like.

In addition, the imaging device 104 may include several hardware components contained within the housing 202 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

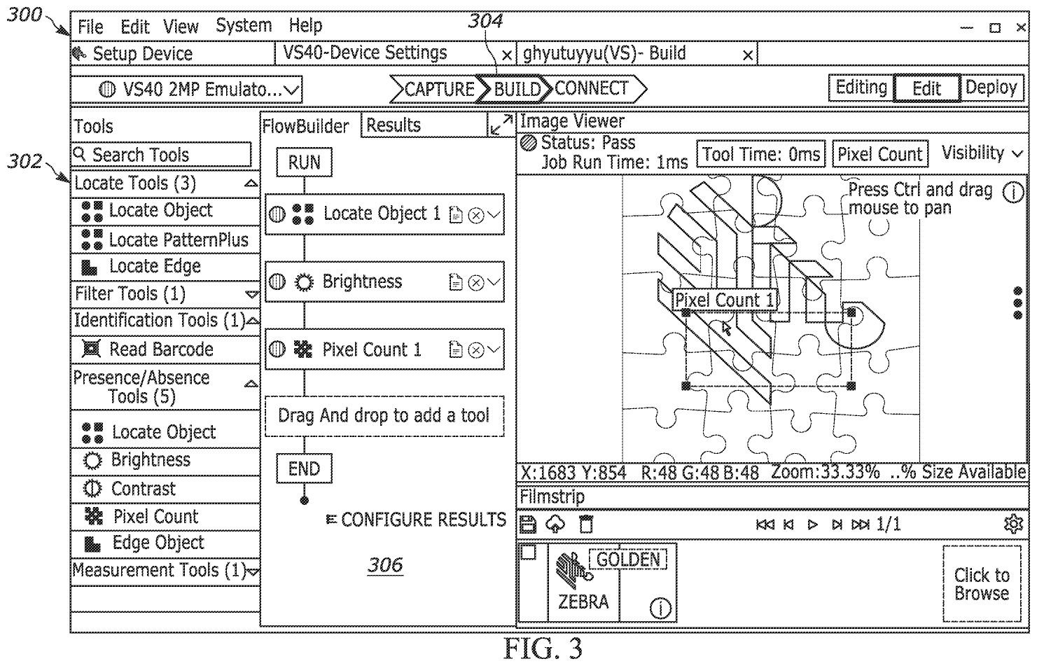

FIG. 3 depicts an example application interface 300 utilized to optimize one or more jobs in accordance with embodiments described herein. Generally, the example application interface 300 may represent an interface of a smart imaging application (e.g., smart imaging application 116) a user may access via a user computing device (e.g., user computing device 102). Specifically, the example application interface 300 may present a user with a series of menus to create a new job or edit a current job. In creating a new job, the user is able to select from a variety of tools which form a particular job. Such tools may include, but are not limited to, (i) a barcode scanning/reading tool, (ii) a pattern matching tool, (iii) an edge detection tool, (iv) a semantic segmentation tool, (v) an object detection tool, (vi) an object tracking tool, (vii) a binarize tool, etc. Additionally, various examples of tools are visible in the left pane 302 of the interface 300.

In some embodiments, to create a job, the user selects the “BUILD” 304 tab to be met with the interface 300. From this point, the user may select any number of tools from the pane 302 by dragging each tool into the center pane 306. When executed, the job is normally executed in a manner where each tool is performed sequentially as provided in the overall job outline. In the example of FIG. 3, it is apparent that three tools have been selected for the job: (1) Locate Object 1; (2) Brightness 1; and (3) Pixel Count 1. If desired, each tool can be further customized to specify various parameters associated with each said tool. To move onto the next stage of the job build, the user can select “END.”

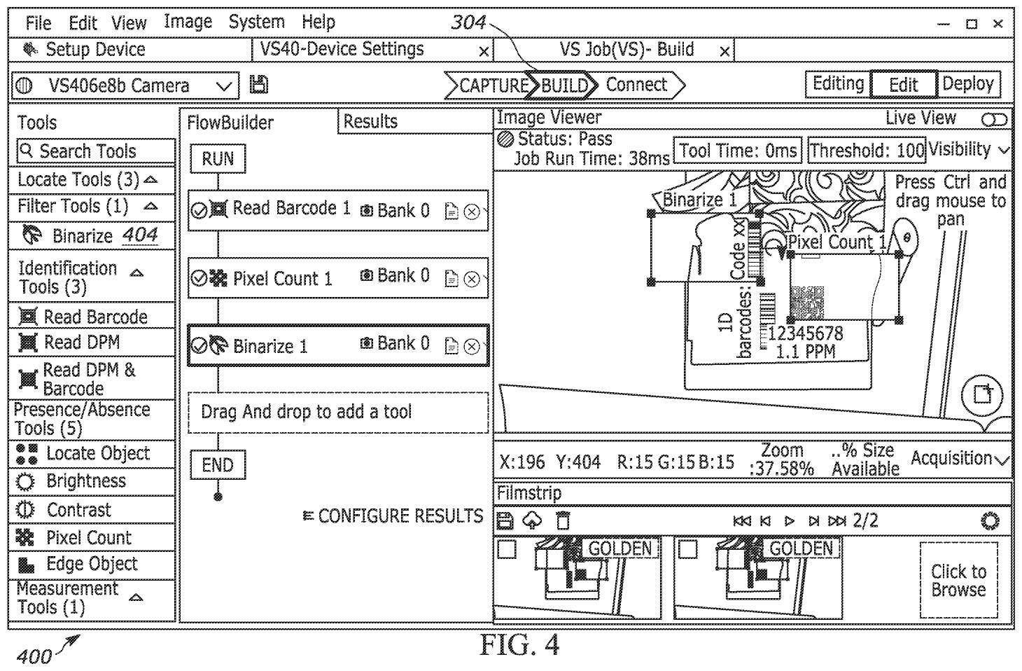

FIG. 4 depicts an additional example application interface 400 utilized to optimize one or more jobs in accordance with embodiments described herein. The example of FIG. 4 includes an application of the binarize tool 404. In some embodiments, the binarize tool takes the portion of the image captured from the ROI and converts it to either a black pixel or white pixel. If the area of focus is a grayscale photo, it may take the tolerance set on the tool, match that against the pixel values in the image, and anything above that tolerance will be a white pixel, and any black value (0-255) below, will be converted to black.

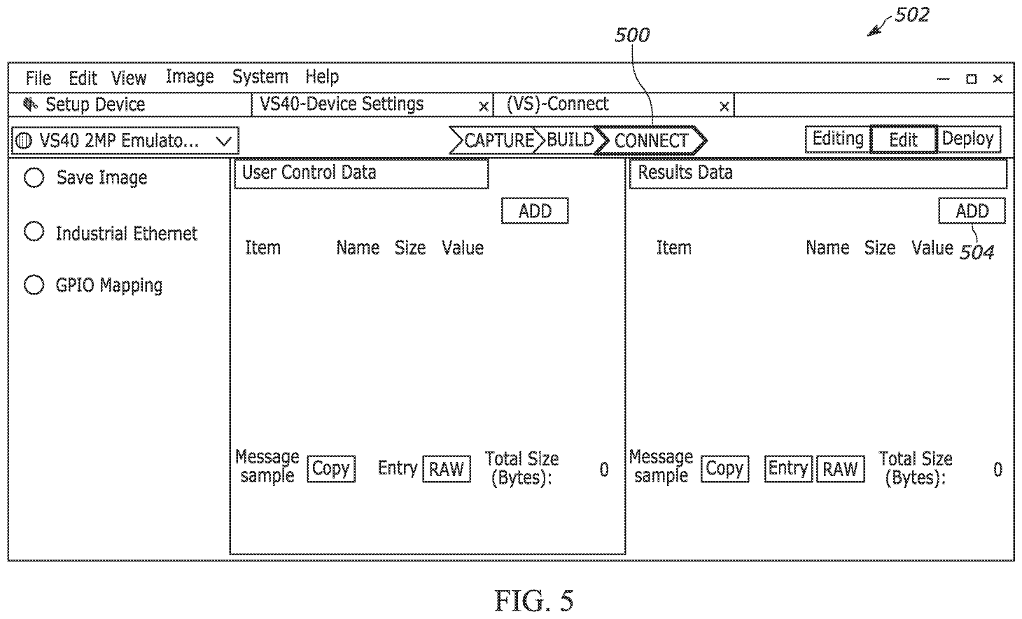

Upon a creation of a job, the user may then select the “CONNECT” tab 500 as shown in FIG. 5 which depicts an exemplary interface 502 for specifying input and output parameters for the imaging device that is to execute the previously built job.

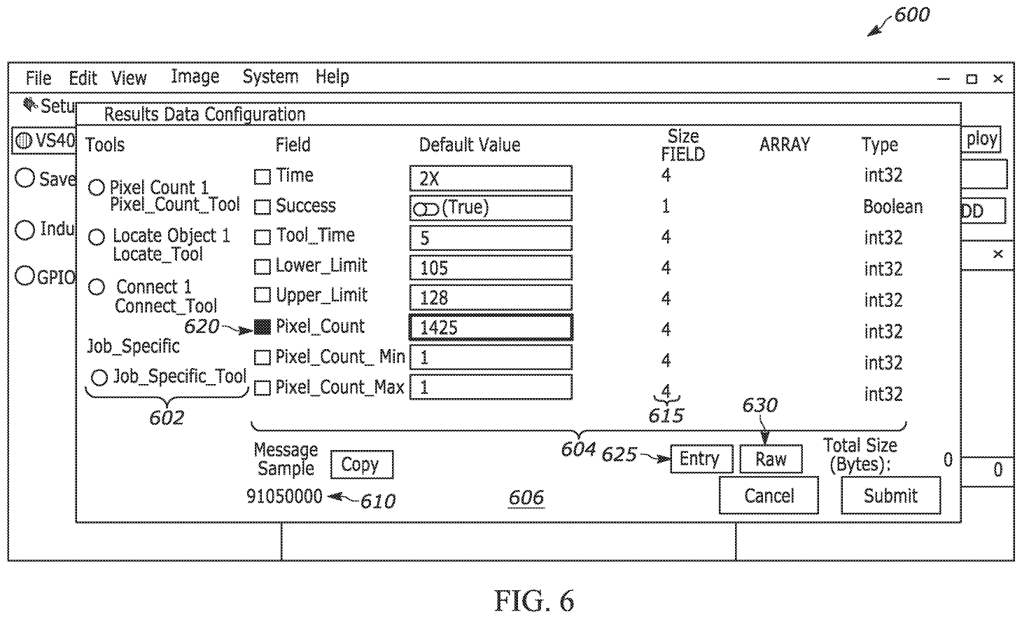

As noted previously, the imaging device (e.g., 104 of FIG. 1) that executes the job often transmits the results of that job to a third-party computing device (e.g., 105 of FIG. 1), like a PLC. Due to the limited processing and programming capabilities of a typical PLC, only certain data can practically be transmitted to the PLC. The designation of which is to be transmitted can be specified by selecting “ADD” 504 from within the Result Data pane of the interface 502. Making this selection brings up interface 600 which is depicted in FIG. 6. Here, the user is provided with three primary panes: the tools pane 602, the output data pane 604, and the preview message pane 606. It should be appreciated that these nomenclatures are merely exemplary and are used to convey the thrust of the operation.

In the tools pane 602, the user selects any one of the previously configured jobs for which it is desired that certain information be transmitted to a third-party device. In the example of FIG. 6, the “Pixel Count 1” job is selected. Once the selection is made, corresponding data outputs for the respective job are provided in the output data pane 604 as a list of selectable items.

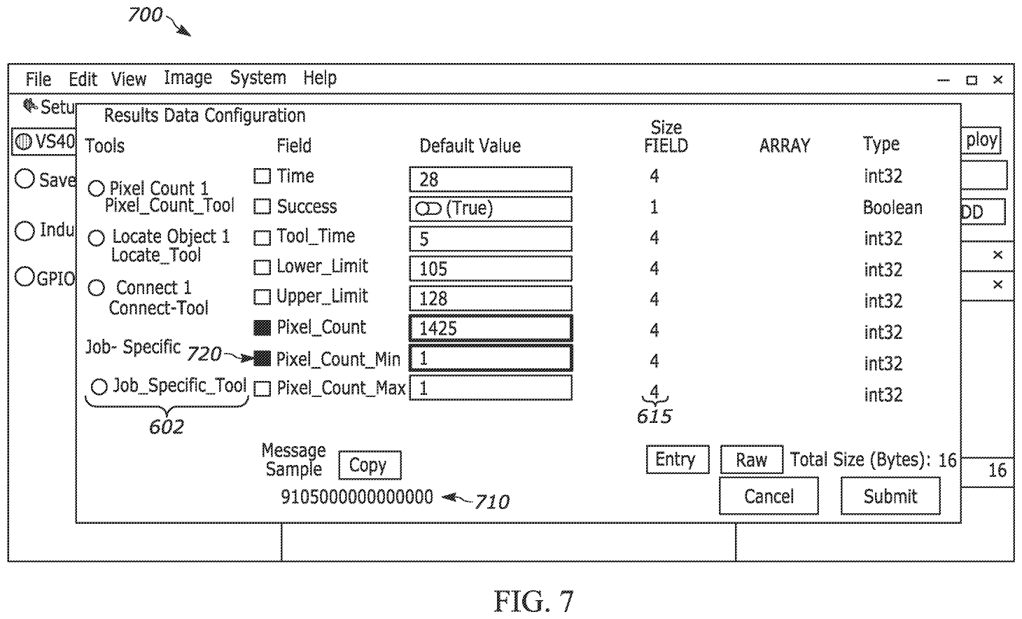

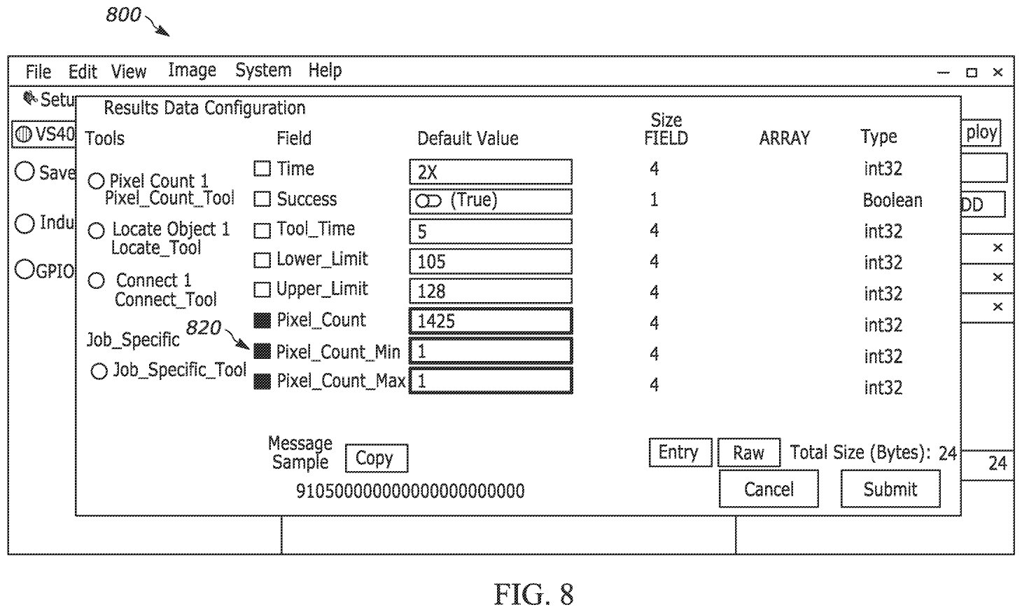

From this point, the user may select any one of the data outputs that are desired to be outputted to an external device. Referring to FIGS. 6-8, one can see a progression of selecting the desired outputs wherein in FIG. 6 the user selects the “pixel_count” output 620, in exemplary interface 700 of FIG. 7 the user selects the “pixel_count_min” output 720, and in exemplary interface 800 of FIG. 8 the user selects the “pixel_count_max” output 820.

Upon a selection of each of the output parameters, in some embodiments, the preview message pane 606 provides a preview message 610, 710, which may be the result data value from one or more of the selected result parameters. This allows a user to determine exactly what data stream will be sent by the imaging device to the third-party device (like a PLC). As can be tracked through the progression of FIGS. 6-7, the preview message changes, from preview message 610 to preview message 710, with the selection of each result parameter. In some embodiments, as in the examples of FIGS. 6-7, the preview message 610, 710 is a decimal representation of the payload message to be transmitted from the imaging device 104 to the control computing device 105. However, the preview message 610, 710 may be made in any suitable form for a protocol between the imaging device 104 and the control computing device 105. For example, rather than decimal form, the preview message 610, 710 may be in any alphanumeric form (e.g., binary, hexadecimal, etc.).

In some embodiments, the preview message may be displayed as an uninterrupted stream of data that will be outputted by the imaging device. In some embodiments, each portion of the preview message that corresponds to some selected result data value may be visually separated from each other portion of the preview message. For example, spaces, hyphens, slashes, etc., may be used to visually identify the separate sections of the preview message 610, 710. In some embodiments, each portion of the preview message may be highlighted with a particular color that corresponds to a selection of a particular result data field. For example, upon the selection of “pixel_count” 620, any part of that row may be highlighted with a particular color. At the same time, the preview message 610, 710 will be modified to include a corresponding binary representation which can also be highlighted (either via a background or via text color) with the same color. In some embodiments, hovering over a particular portion of the preview message 610, 710 may bring up a floating window indicating which result data parameter that portion corresponds to. Along the same lines, in some embodiments, hovering over a result data parameter may bring up a floating window indicating which part of the preview message 610, 710 corresponds to that result data parameter.

Furthermore, a user may select between entry mode (e.g., by pressing entry mode button 625) and raw data mode (e.g., by pressing raw data mode button 630). In entry mode, in some embodiments, a header comprising metadata is added to the output message. In some implementations, the metadata comprises message size information. In raw data mode, in some embodiments, no header is added to the displayed output message.

In some embodiments, an image (e.g., a prior image or test image) may be loaded prior to proceeding to the Result Data Configuration portion of the application. This can allow sample data to be seen in the various values associated with the result data values. Furthermore, upon the selection of each result data, the result values may be manually edited to determine how these edits may impact the preview message. Additionally, the user can edit the default values, save those defaults with the job for future editing. The user can also edit (e.g., in the size field 615) the size of the defaults being sent, as well as the max-size of the array in cases of collections of result data (multiple barcodes) that are sent over the PLC.

To further explain, to produce the preview message 610, 710, in some embodiments, an image (e.g., the prior image or test image) may be loaded into the memory 120. The image may come from any suitable source. For instance, the user may upload an image from his smartphone, or the prior image may be an image from a previous job run, a simulated image, a default image, etc. Subsequently, from the image, the processor 118 produces the dataset used to produce the preview message 610, 710. In some embodiments, if any or all of the data required to produce the preview message 610, 710 is not in the image (or dataset that is produced from the image), default data may be used instead. For example, if the image loaded into the memory 120 does not contain a barcode, default data may be used instead to create the preview message 610, 710 (if the job required information of a barcode).

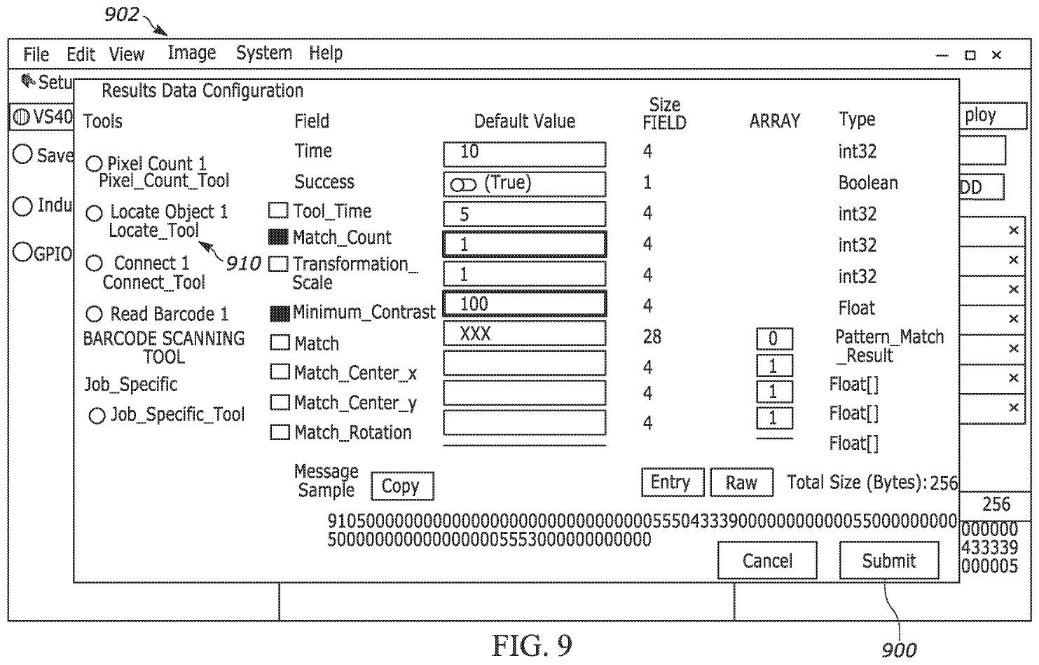

Once the selection process is completed for a particular tool, the user may switch to another tool within the tools pane 602. Such a transition is shown in FIG. 9 where the exemplary interface 902 shows that the user has transitioned to the “Locate Object 1” tool 910. As with the previous tool, the user is again able to select any desired result data parameter to be included in the output of the imaging device. Notably, selections made in the initial (or any other) tool configuration are not discounted. Instead, the preview message continues to be amended based on all of the result data fields that is selected.

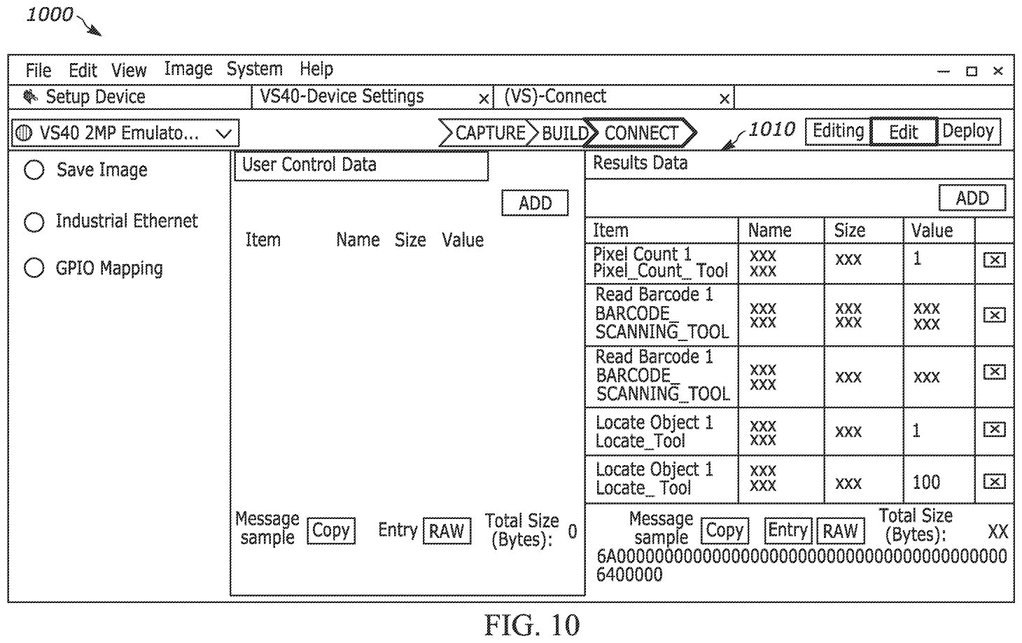

Upon the completion of the selection of all necessary result data fields, the user selects “SUBMIT” 900 for the settings to be saved and for the application to revert back to the previous screen, as depicted in exemplary interface 1000 of FIG. 10. As can be seen therein, at this point the “Result Data” pane 1010 has been populated based on the previously made selections, and a preview message for these selections is provided therebelow.

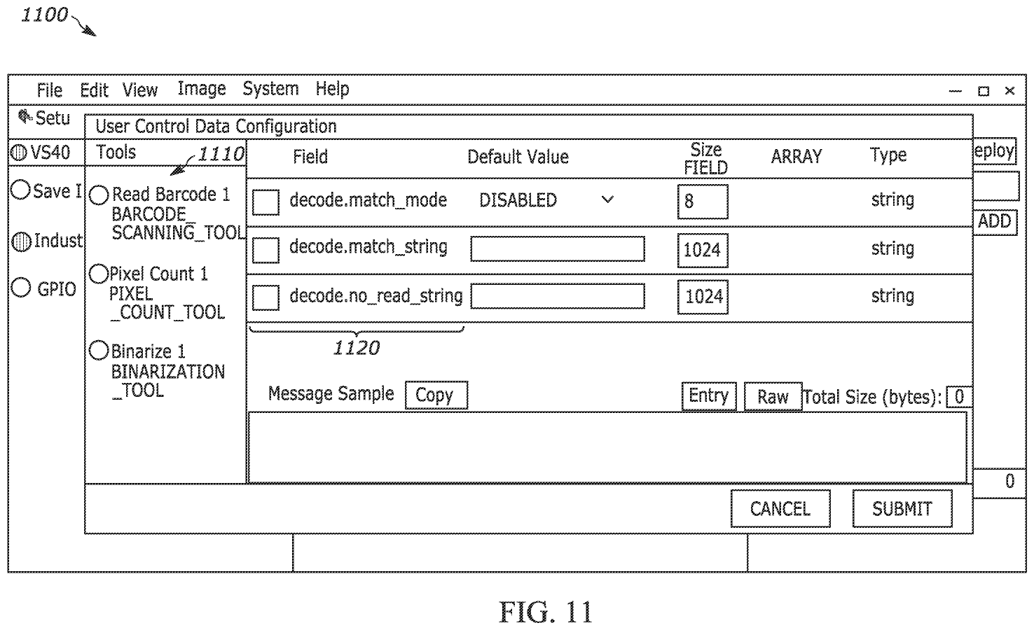

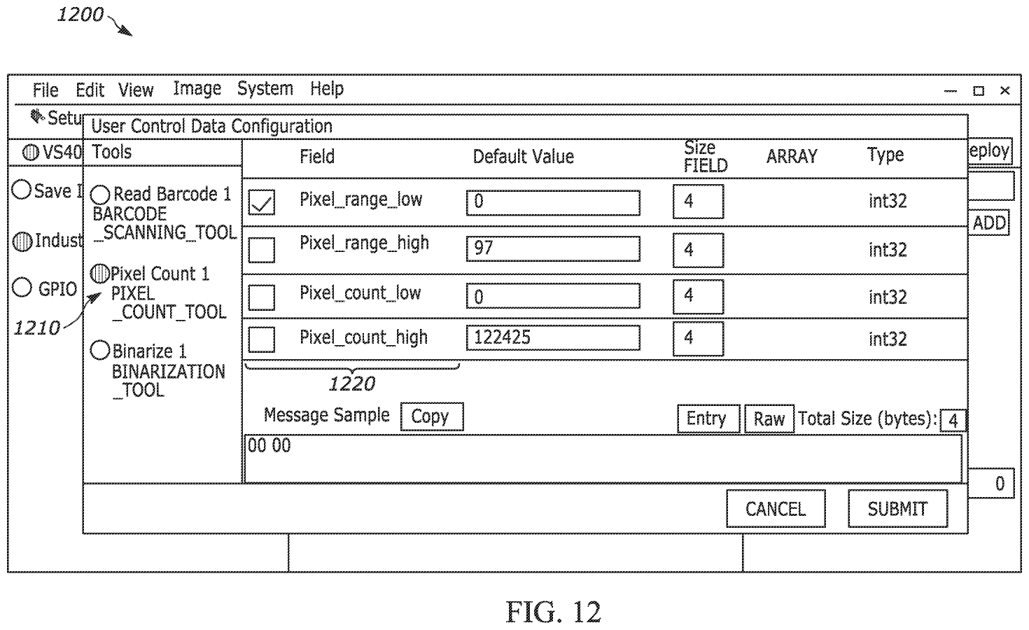

FIGS. 11 and 12 show additional examples. Specifically, FIG. 11 shows an example screen 1100 where the “Read Barcode 1” tool 1110 has been selected, and field column (has been accordingly populated (e.g., with “decode.match_mode,” “decode.match_string,” and “decode.no_read_string”). FIG. 12 shows an example screen 1200 where the “Pixel Count 1” tool 1210 has been selected, and field column 1220 has been accordingly populated (e.g., with “pixel_range_low,” “pixel_range_high,” “pixel_count_low,” and “pixel_count_high”).

It should be appreciated that a similar approach can be implemented on an input side of the imaging device 104 whereby a user can specify which inputs are desired to be received at the imaging device 104. The specification of these inputs can similarly provide a preview message that would be required to be outputted by the PLC (or a third party computing device) so that proper communication may take place. This “reverse” process is useful in the situation where the control computing device 105 is used to control the imaging device 104 (e.g., where the control computing device 105 sends data to the imaging device 104 to alter the job “on the fly”).

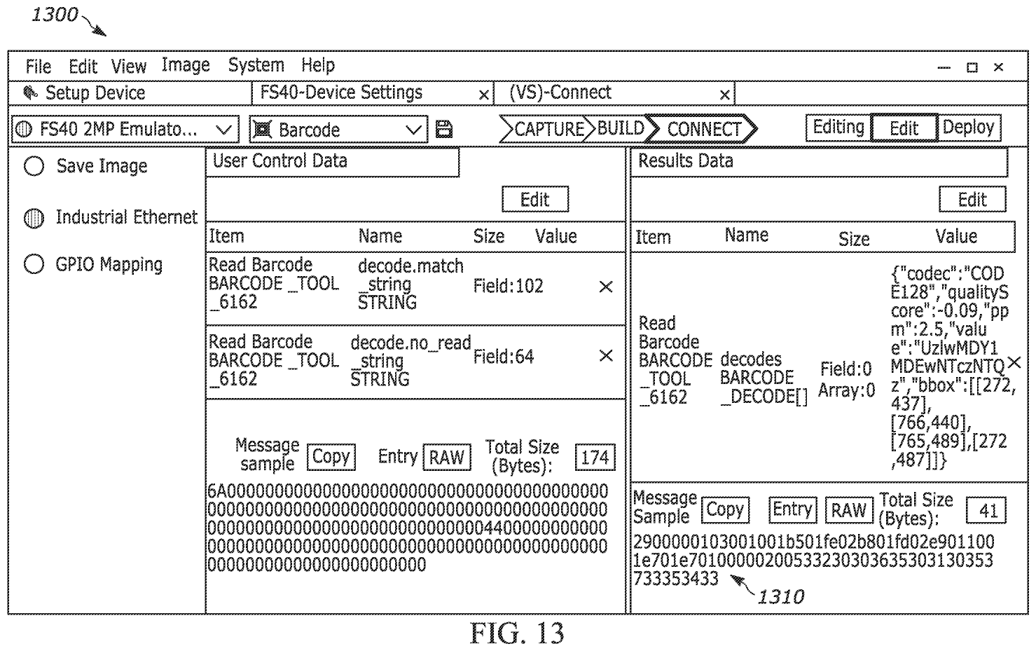

In this regard, FIG. 13 illustrates an example screen 1300 to display a representation of an input message to be input to the imaging device. Specifically, in the example screen 1300, the “Read Barcode” tool has been selected, and the preview input message 1310 is displayed.

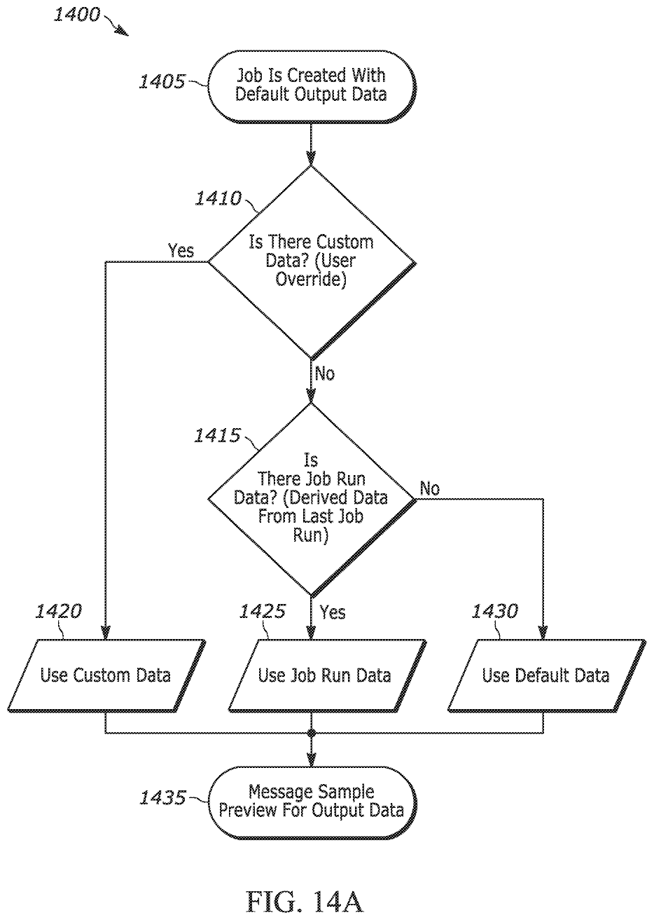

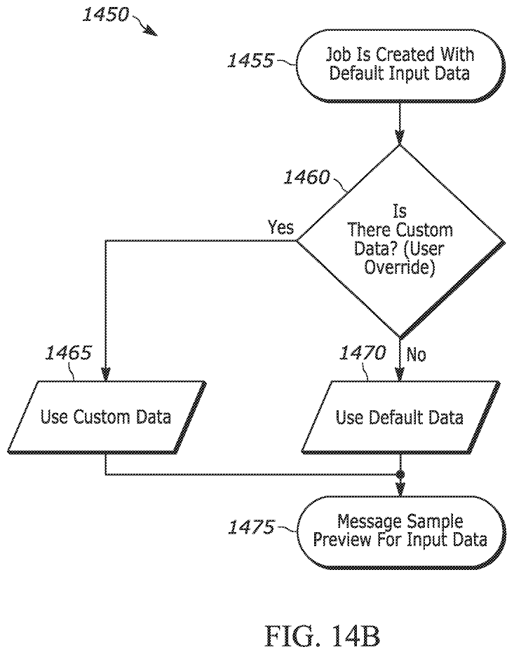

FIG. 14A illustrates an example of determining sample preview of output data, whereas FIG. 14B illustrates an example of determining a sample preview of input data. In the example method 1400 of FIG. 14A, at block 1405, a job is created with default output data (e.g., data that would be outputted from the imaging device 104 to the control computing device 105). At block 1410, it is determined if there is custom data (e.g., user-entered data). In this regard, it should be understood that the user may enter data in any suitable way. For instance, the user may enter data into the output pane 604, thereby “overriding” default values previously in the output pane 604. If there is custom data, the custom data is used instead of the default output data at block 1420 in calculation of the message preview.

If there is no custom data, it is determined if there is job run data (e.g., from a job run on the prior image discussed above, or from a previously run job, etc.) at block 1415. If so, the job run data is used in the determination of the message preview at block 1425. If not, the default data is used in the determination of the message preview at block 1430.

At block 1435, the message sample preview is assembled. It should be understood that, in some embodiments, the blocks 1410-1430 may be performed iteratively through each of the fields (e.g., each of the rows in the output pane 604) before the complete message sample preview is assembled at block 1435. In this way, the default values may be used for some fields, while the user-entered data is used for other fields, and/or previously acquired job run data is used for still other fields.

FIG. 14B depicts an example of determining a preview message of data that would be input to the imaging device 104 from the control computing device 105. As mentioned above, this “reverse” process is useful in the situation where the control computing device 105 is used to control the imaging device 104 (e.g., where the control computing device 105 sends data to the imaging device 104 to alter the job “on the fly”). At block 1455, a job is created with default input data. At block 1460, it is determined if there is custom data (e.g., user-entered data). In this regard, it should be understood that the user may enter data in any suitable way. For instance, the user may enter data at the control computing device 105, the imaging device 104 and/or the user computing device 102.

If there is custom data, the custom data is used in the determination of the preview message at block 1465. If there is no custom data, the default data is used in the determination of the preview message at block 1470. At block 1475, the message sample preview is assembled. It should be understood that, in some embodiments, the blocks 1460-1470 may be performed iteratively through each of the fields of the input message before the complete message sample preview is assembled at block 1475. In this way, the default values may be used for some fields, while the user-entered data is used for other fields.

It should further be appreciated that the preview message may be formatted based on a default formatting scheme or based on the expected protocol that is to be used for communication between the imaging device and the third party computing device 105 like a PLC. Thus, in some instances the preview message may be a binary message, it may be a decimal message, it may include alphanumeric characters, or it may be formatted in any way that is compatible with the implemented protocol.

The approach described herein can be particularly beneficial as it provides insight into the specific message that is transmitted from the imaging device to a third party computing device, and helps delineate various portions of that message. Having this information makes it possible to program the third party computing device 105 (like a PLC) with considerably greater ease as the content of the message is no longer unknown. In other words, while the PLC programmer may normally be aware of the general content of the payload being transmitted thereto (e.g., the fact that the message includes a pixel count), that programmer is normally not aware of what portion of the message represents said pixel count. Such lack of knowledge creates obstacles to efficient programming of the PLC and effective communication between the imaging devices and the PLC. Approaches disclosed herein help address and overcome this difficulty.

### Example Methods

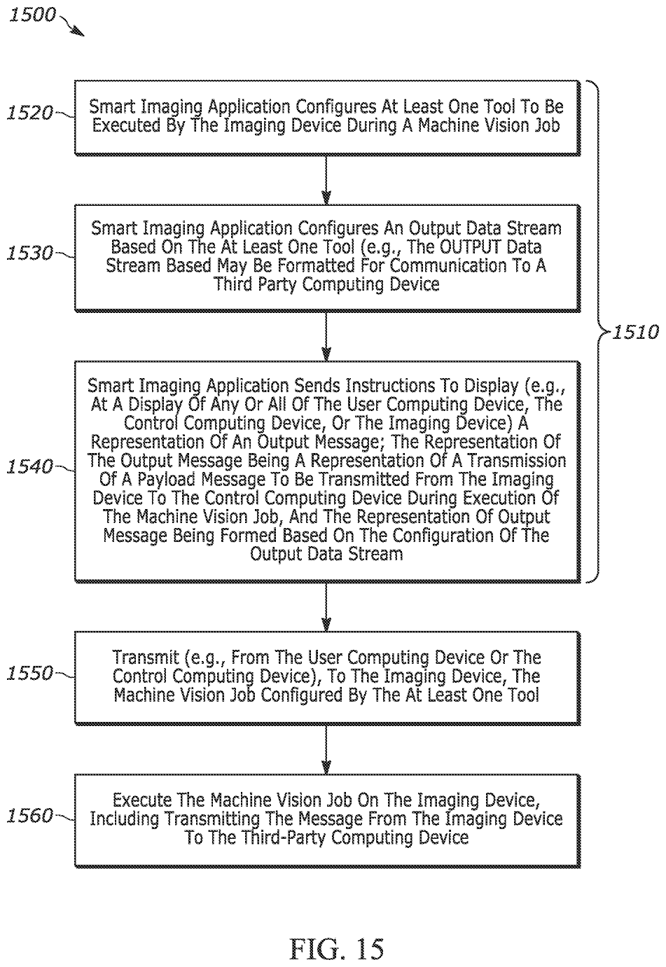

FIG. 15 illustrates an example method 1500 of displaying a representation of a transmission of a message output from the imaging device to the third party computing device. The example method 1500 begins by configuring (e.g., via the application(s) 116 and/or 156) the machine vision job (e.g., by performing series of blocks 1510). More specifically, in some embodiments, the configuring the machine vision job may include configuring at least one tool to be executed by the imaging device during an execution of the job (e.g., block 1520). In some implementations, the configuring the at least one tool includes: (i) displaying, based on the at least one tool, a plurality of fields (e.g., field columns 1120, 1220) for selection by a user; (ii) receiving, from the user, a selection of at least one field of the plurality of fields; and (iii) configuring the at least one tool further based on the selected at least one field.

At block 1530, the configuring the machine vision job may further include configuring an output data stream based on the at least one tool, the output data stream being formatted for communication to the third-party computing device. At block 1540, the configuring of the machine vision job may further include displaying, via the application 116, 156, a representation of an output message, the representation of the output message being formed based on the configuring the output data stream, the representation of the output message being a representation of a transmission of a payload message from the imaging device to the third-party computing device. In some embodiments, if there is user-entered data (e.g., as determined at block 1410 of FIG. 14A), the displayed output message is formed further based on the user-entered data. Furthermore, it should be understood that the type of data (e.g., user-entered, previously acquired job run data, or default data, as illustrated in the example of FIG. 14A) used may be different for each tool or each field. For instance, in the example screen 1200 of FIG. 12, if a user selects the fields “pixel_range_low” and “pixel_range_high,” and further enters data only for “pixel_range_low,” the user-entered data would be used for “pixel_range_low,” but previously acquired job data or default data would be used for “pixel_range_high.” In this regard, it should be understood that, in some implementations, some or all of the blocks of the example method 1400 of FIG. 14A occur at block 1540 of FIG. 15 to determine what data is used for the calculation of the representation of the output message.

At block 1550, the machine vision job is transmitted (e.g., from the user computing device or the control computing device) to the imaging device. At block 1560, the machine vision job is executed on the imaging device, which may include transmitting the message from the imaging device to the third-party computing device.

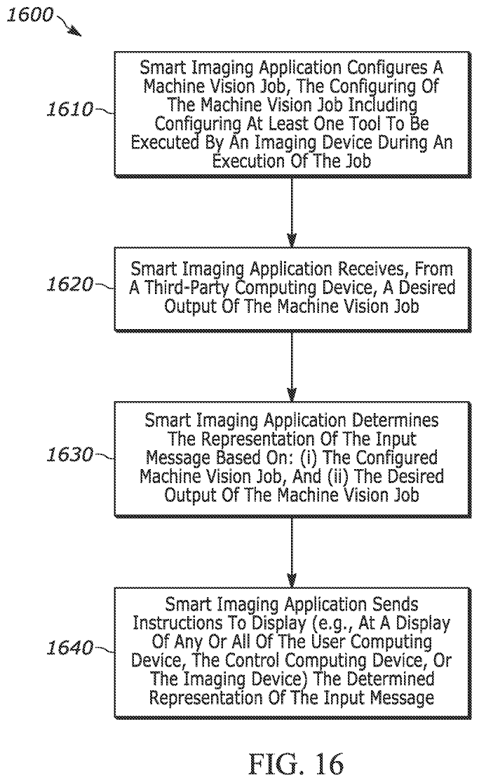

FIG. 16 illustrates an example method 1600 of displaying a representation of a transmission of a message input to the imaging device from the third party computing device. The example method 1600 begins, at block 1610, by configuring (e.g., via the application(s) 116 and/or 156) the machine vision job. At block 1620, a desired output of the machine vision job is received from a third-party computing device.

At block 1630, the representation of the input message is determined based on: (i) the configured machine vision job, and (ii) the desired output of the machine vision job. In some embodiments, the desired output of the machine vision job is calculated wholly or partially as in the example method 1450 of FIG. 14B.

At block 1640, the determined representation of the input message is displayed.

It should be understood that the example methods 1500, 1600 may be performed in whole or in part by any suitable component(s) illustrated in FIG. 1. For instance, either of the example methods may be performed by one or both of the smart imaging application(s) 116 and/or 156.

Additionally, it is to be understood that each of the actions described in the example methods 1500, 1600 may be performed in any order, number of times, or any other suitable combination(s). For example, some or all of the blocks of the methods 1500, 1600 may be fully performed once or multiple times. In some example implementations, some of the blocks may not be performed while still effecting operations herein.

### ADDITIONAL CONSIDERATIONS

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for operating a machine vision system, the machine vision system including a computing device for executing an application and an imaging device communicatively coupled to the computing device, the imaging device being operable to communicate with a third-party computing device, the method comprising:
configuring, via the application, a machine vision job, the configuring the machine vision job including:
configuring at least one tool to be executed by the imaging device during an execution of the job;
configuring an output data stream based on the at least one tool, the output data stream being formatted for communication to the third-party computing device; and
displaying, via the application, a representation of an output message, the representation of the output message being formed based on the configuring the output data stream, the representation of the output message being a representation of a transmission of a payload message from the imaging device to the third-party computing device;
transmitting, from the computing device to the imaging device, the machine vision job; and
executing the machine vision job on the imaging device, wherein, the executing the machine vision job includes transmitting the payload message from the imaging device to the third-party computing device.

2. The method of claim 1, wherein the representation of the output message is a binary representation of the output data stream.

3. The method of claim 1, wherein the displaying the representation of the output message occurs in response to the configuring the output data stream.

4. The method of claim 1, wherein the third-party computing device is a programmable logic controller (PLC).

5. The method of claim 1, wherein configuring an output data stream based on the at least one tool further comprises:
displaying, based on the at least one tool, a plurality of fields for selection by a user;
receiving, from the user, a selection of at least one field of the plurality of fields; and
configuring the at least one tool further based on the selected at least one field.

6. The method of claim 5, wherein configuring an output data stream based on the at least one tool further comprises:
displaying a size field for each field of the plurality of fields;
receiving, from a user, an input for at least one of the size fields; and
configuring the output data stream further based on the received input.

7. The method of claim 1, wherein displaying, via the application, a representation of an output message further comprises:
displaying the representation of the output message in an entry mode by adding a header comprising metadata to the output message.

8. The method of claim 1, wherein displaying, via the application, a representation of an output message further comprises:
displaying the representation of the output message in a raw data mode by displaying raw data of the output message, and not adding a header comprising metadata to the output message.

9. The method of claim 1, wherein the configuring the output data stream based on the at least one tool includes executing each of the at least one tool with a respective input data set to receive a corresponding output data set.

10. The method of claim 1, wherein the representation of the output message is formed further based on a prior image.

11. A machine vision system comprising:
a computing device for executing an application, the application operable to configure a machine vision job, wherein configuring the machine vision job includes:
configuring at least one tool to be executed by the imaging device during an execution of the job;
configuring an output data stream based on the at least one tool, the output data stream being formatted for communication to a third-party computing device; and
displaying, via the application, a representation of an output message, the representation of output message being formed based on the configuring the output data stream, the output message being a representation of a transmission of a payload message from the imaging device to the third-party computing device, wherein the displayed representation of the output message is formed further based on at least one of: (i) user-entered data, (ii) prior image data, or (iii) default data;
the application being further operable to cause the computing device to transmit the machine vision job to an imaging device; and
the imaging device configured to receive the machine vision job and to execute the machine vision job which includes transmitting the payload message from the imaging device to the third-party computing device.

12. The system of claim 11, wherein configuring the machine vision job further includes forming the displayed representation of the output message further based on the user-entered data.

13. The system of claim 11, wherein configuring the machine vision job further includes forming the displayed representation of the output message further based on the prior image data.

14. The system of claim 11, wherein the representation of the output message is a binary representation of the output data stream.

15. The system of claim 11, wherein the displaying the representation of the output message occurs in response to the configuring the output data stream.

16. The system of claim 11, wherein the third-party computing device is a programmable logic controller (PLC).

17. The system of claim 11, wherein displaying, via the application, a representation of an output message further comprises:
displaying the representation of the output message in an entry mode by adding a header comprising metadata to the output message.

18. A machine vision system comprising:
a computing device for executing an application, the application operable to configure a machine vision job, and the application further operable to display a representation of an input message by:
configuring, via the application, a machine vision job, the configuring the machine vision job including configuring at least one tool to be executed by an imaging device during an execution of the job;
receiving, from a third-party computing device, a desired output of the machine vision job;
determining, via the application, the representation of the input message based on: (i) the configured machine vision job, and (ii) the desired output of the machine vision job; and
displaying, via the application, the determined representation of the input message.

19. The system of claim 18, further comprising the imaging device, wherein the imaging device is configured to receive the machine vision job and to execute the machine vision job which includes transmitting a payload message from the imaging device to the third-party computing device.

20. The system of claim 18, wherein the third-party computing device comprises a programmable logic controller (PLC).
